(19) United States
(12) Patent Application Publication
(10) Pub. No.: US 2025/0269660 A1
(43) Pub. Date: Aug. 28, 2025

(54) LIQUID EJECTION APPARATUS AND CIRCULATION STATE DETERMINATION METHOD

(71) Applicant: CANON KABUSHIKI KAISHA, Tokyo (JP)

(72) Inventors: MASAKI NITTA, Kanagawa (JP); HIROSHI TAIRA, Tokyo (JP); HIROSHI KAWAFUJI, Tokyo (JP); SHUNNOSUKE KOSEKI, Kanagawa (JP); TAKESHI MURASE, Kanagawa (JP); SAE MOGI, Kanagawa (JP)

(21) Appl. No.: 19/062,881

(22) Filed: Feb. 25, 2025

(30) Foreign Application Priority Data
Feb. 27, 2024 (JP) 2024-027404

(51) Int. Cl. B41J 2/18; B41J 2/14; B41J 29/46

(52) U.S. Cl. CPC B41J 2/18; B41J 2/14112; B41J 2/14153; B41J 29/46

(57) ABSTRACT

A liquid ejection apparatus and a circulation state determination method capable of helping prevent problems caused by a malfunction. An ejection state detected after a lapse of a first period of time and an ejection state detected after a lapse of a second period of time shorter than the first period of time are compared with each other to detect whether an ink circulation operation is performed faultily.

### BACKGROUND

### Field

The present disclosure relates to a liquid ejection apparatus that ejects circulating liquid and also to a circulation state determination method.

### Description of the Related Art

In a liquid ejection apparatus having a circulation mechanism for circulating liquid such as ink, continued use under an abnormal circulation state may cause adherence of ink or settling of ink inside the pressure chambers, resulting in needing, e.g., replacement of the liquid ejection head. Examples of the abnormal circulation state include a case where the circulation mechanism stops operating and a case where the circulation mechanism is operating normally, but clogging or the like is occurring somewhere on a circulating path. Also, the timing at which abnormal circulation starts varies: immediately after the circulation mechanism is operated or while a liquid ejection operation is performed.

Because of the various possible causes and timings for abnormal circulation, it is difficult to detect the state of circulation with high accuracy in a timely manner.

Japanese Patent Laid-Open No. 2012-183806 discloses a method for detecting abnormality in a circulation path by measuring a supply amount and a collection amount based on a pressure difference in an ink flow channel and the number of rotations of a circulation pump.

The method of Japanese Patent Laid-Open No. 2012-183806, however, fails to detect a change in the ejection state caused by degradation of circulation capability. Specifically, the method cannot detect adherence of a liquid component to the ejection ports and faulty ejection caused as a result of that. This may consequently lower the quality of a product outputted from the liquid ejection apparatus. For example, in a case of an inkjet printing apparatus, image quality may lower.

### SUMMARY

Thus, the present disclosure provides a liquid ejection apparatus and a circulation state determination method capable of detecting a change in the ejection state caused by degradation of circulation capability.

To this end, a liquid ejection apparatus of the present disclosure is a liquid ejection apparatus having: an ejection unit that ejects liquid in a pressure chamber from an ejection port using an action of a pressure generation element; a replacement unit that replaces the liquid in the pressure chamber; an ejection state detection unit that detects an ejection state of the liquid ejected from the ejection port; and a flaw detection unit that detects a flaw in an operation by the replacement unit based on the ejection state of the liquid detected by the ejection state detection unit.

The present disclosure can provide a liquid ejection apparatus and a circulation state determination method capable of helping prevent problems caused by a malfunction.

Further features of the present disclosure will become apparent from the following description of exemplary embodiments with reference to the attached drawings.

### BRIEF DESCRIPTION OF THE DRAWINGS

FIG. 1 is a perspective view schematically showing a liquid ejection apparatus.

FIG. 2 is a block diagram showing the configuration of a print control system of the liquid ejection apparatus.

FIG. 3 is an exploded perspective view of a liquid ejection head.

FIG. 4 is a diagram showing the configuration of flow channels in the liquid ejection head.

FIG. 5 is a schematic diagram showing a flow channel configuration for one color in the liquid ejection head.

FIGS. 6A, 6B, and 6C are schematic diagrams showing the structure of a second pressure adjustment unit.

FIGS. 7A, 7B, 7C, and 7D are diagrams showing the flow of ink in the liquid ejection head in respective phases of an operation of a circulation pump.

FIG. 8 is a rough schematic diagram showing an ejection speed measurement unit and part of the liquid ejection head.

FIG. 9 is a flowchart showing processing performed in a circulation operation check sequence.

FIG. 10 is a rough schematic diagram showing an area near ejection ports.

FIG. 11 is a flowchart showing processing performed in a circulation operation check sequence.

FIG. 12 is a rough schematic diagram showing an ejection state detection unit.

FIG. 13 is a graph showing a temperature profile for normal ejection and a temperature profile for failed ejection.

FIG. 14 is a flowchart showing processing performed in a circulation operation check sequence.

FIG. 15A is a flowchart of a recovery sequence, and FIG. 15B is a table showing drive frequencies.

### DESCRIPTION OF THE EMBODIMENTS

### First Embodiment

A first embodiment of the present disclosure is described below with reference to the drawings.

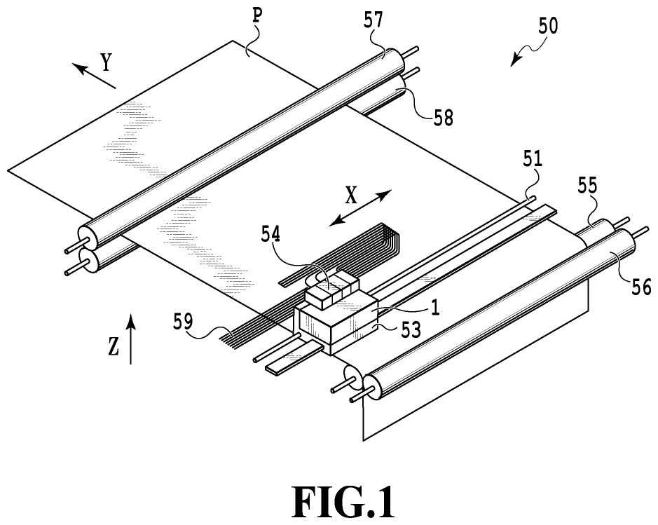

FIG. 1 is a perspective view schematically showing a liquid ejection apparatus 50 on which a liquid ejection head 1 is mountable. The liquid ejection apparatus 50 is a serial-type inkjet printing apparatus that performs printing on a print medium P by ejecting liquid, i.e., an ink, while scanning the liquid ejection head 1. The liquid ejection head 1 is mounted on a carriage 53, and the carriage 53 reciprocates in an X-direction along a guide shaft 51. The print medium P is conveyed by conveyance rollers 55, 56, 57, 58 in a Y-direction, which is orthogonal to the X-direction. The liquid ejection head 1 is supplied with ink from ink supply tubes 59 connected to an ink tank (not shown).

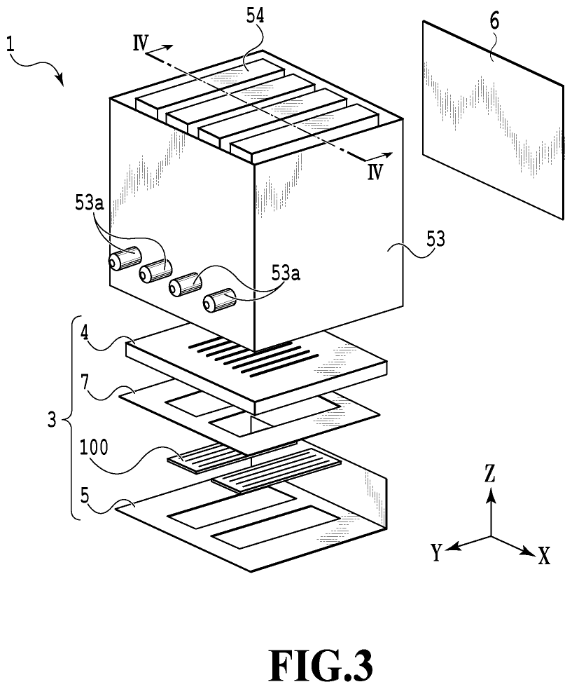

The liquid ejection head 1 is configured including circulation units 54 and an ejection unit 3 to be described later (see FIG. 3 to be referred to later). The ejection unit 3 is provided with a plurality of ejection ports and energy generation elements (hereinafter referred to as heat generation resistance elements) that produce ejection energy for ejecting liquid from the respective ejection ports. A specific configuration of the ejection unit 3 will be described later.

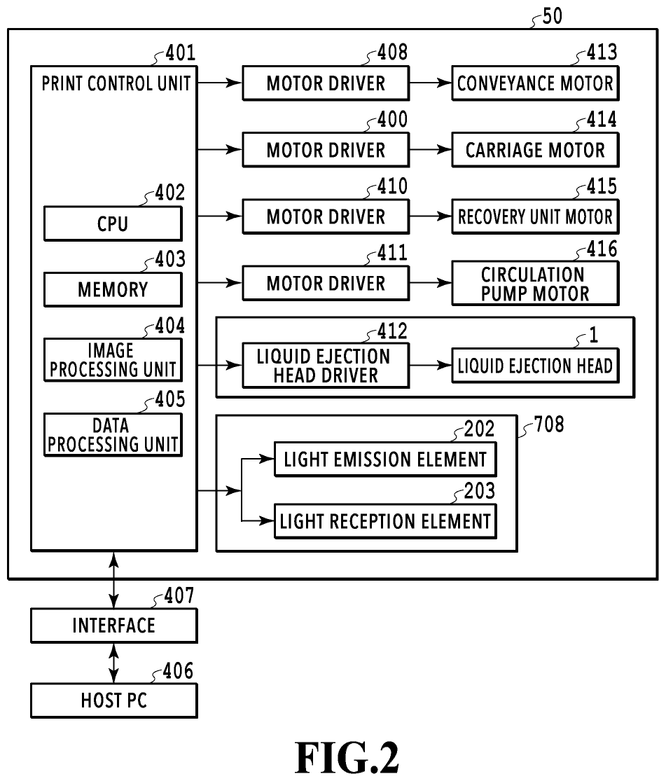

FIG. 2 is a block diagram showing the configuration of a print control system of the liquid ejection apparatus 50. The liquid ejection apparatus 50 is connected to a data supply apparatus such as a host personal computer (PC) 406 via an interface 407. Various kinds of data, control signals related to printing, and the like transmitted from the host PC 406 are inputted to a print control unit 401 of the liquid ejection apparatus 50. The print control unit 401 includes memory 403 to store input image data and intermediate products such as multivalued gray-scale data and multi-pass mask patterns and a central processing unit (CPU) 402 (which may include one or more processors, an application-specific integrated circuit (ASIC), or the like) as a control and computing device. The print control unit 401 controls motor drivers and a liquid ejection head driver 412 to be described later, according to control signals inputted thereto via the interface 407. The print control unit 401 has an image processing unit 404 and a data processing unit 405 and performs predetermined image processing on image data inputted thereto.

A conveyance motor 413 drives and rotates the conveyance rollers 55, 56, 57, and 58 that convey the print medium P. A carriage motor 414 drives the carriage 53 having the liquid ejection head 1 mounted thereon in a reciprocating manner. A recovery unit motor 415 is a motor provided to a recovery unit and operates a suction pump and the like. A circulation pump motor 416 drives a circulation pump in the liquid ejection head 1. Motor drivers 408, 409, 410, and 411 drive the conveyance motor 413, the carriage motor 414, the recovery unit motor 415, and the circulation pump motor 416, respectively. The liquid ejection head driver 412 drives the liquid ejection head 1. In a case where a plurality of liquid ejection heads is mounted, a plurality of liquid ejection head drivers 412 are provided correspondingly.

The print control unit 401 controls a light emission element 202 and a light reception unit 203 in an ejection speed measurement unit 708.

FIG. 3 is an exploded perspective diagram of the liquid ejection head 1 of the present embodiment. The liquid ejection head 1 is configured including the circulation units 54 and the ejection unit 3 for ejecting ink supplied from the circulation units 54 onto the print medium P.

In the present embodiment, the liquid ejection head 1 is configured to be able to eject inks in four colors. Ink connector insertion ports 53a are provided in correspondence to the respective ink supply tubes, forming individual supply channels.

The ejection unit 3 includes two ejection modules 100, a first support member 4, a second support member 7, and an electric wiring member 5. The ejection modules 100 of the ejection unit 3 each include a silicon substrate and a plurality of heat generation resistance elements (heaters) provided on one side of the silicon substrate as energy generation elements used for ink ejection. Also, electric wiring for supplying power to each heat generation resistance element is formed on the silicon substrate of the ejection module 100 using a film formation technique. Formed in the silicon substrate are a plurality of ink flow channels corresponding to the heat generation resistance elements and pressure chambers provided with a plurality of ejection ports from which ink is ejected. Ink supply ports for supplying ink to the plurality of ink flow channels and ink collection ports open at the back surface of the silicon substrate. Note that the energy generation elements are not limited to heat generation resistance elements (heaters) and may be piezoelectric elements. Ink is ejected from the ejection ports by the action of the energy generation elements.

The ejection modules 100 are bonded and secured to the first support member 4 that has the ink supply ports and the ink collection ports. The second support member 7 having openings are bonded and secured to the first support member 4. The second support member 7 holds the electric wiring member 5 in such a manner that the electric wiring member 5 is electrically connected to a print element substrate. The electric wiring member 5 applies electric signals for ink ejection to the ejection modules 100. Power is supplied to the electric wiring member 5 from an electric contact substrate 6 provided to a side surface of the carriage 53.

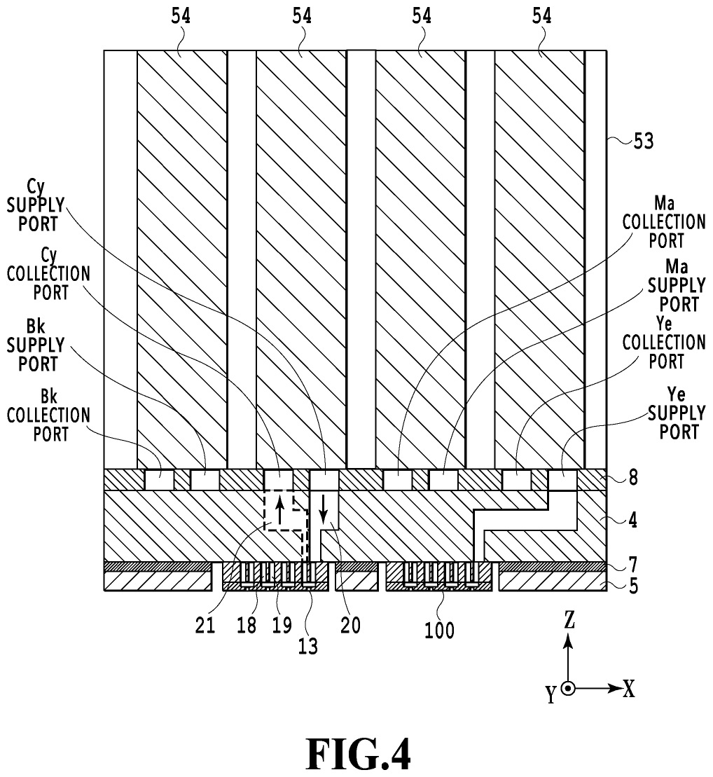

FIG. 4 is a sectional view taken along the line IV-IV in FIG. 3 and is a diagram showing the configuration of flow channels in the liquid ejection head 1. The liquid ejection head 1 includes ejection port arrays each being formed of a plurality of ejection ports 13 arrayed in the Y-direction. The liquid ejection head 1 is provided with individual supply flow channels 19 and individual collection flow channels 18 to circulate ink at the respective ejection ports. The individual supply flow channels 19 and the individual collection flow channels 18 are provided along the ejection port array. A supply flow channel 20 is formed in the first support member 4, at a given section thereof. The supply flow channel 20 is connected to the individual supply flow channels 19, and the individual supply flow channels 19 are connected to the circulation unit 54 for the corresponding color via the supply flow channel 20 and a joint member 8. Also, a collection flow channel 21 is formed in the first support member 4, at a different section thereof. The collection flow channel 21 is connected to the individual collection flow channels 18 and is connected to the circulation unit 54 for the corresponding color through the joint member 8.

The arrows in FIG. 4 indicate the direction of ink flow. Ink flows from the circulation unit 54, to the supply flow channel 20 through the supply port in the joint member 8, to the individual supply flow channels 19, and then to the ejection ports 13. Part of the ink supplied to the ejection ports 13 is ejected from the ejection ports 13, and un-ejected part of the ink returns to the circulation unit 54 by flowing through the individual collection flow channels 18, the collection flow channel 21, and the collection port in the joint member 8. The electric wiring member 5 is supported by the second support member (not shown) and is electrically connected to the ejection modules 100. A flow channel configuration similar to the one described above is provided for each of the circulation units 54 for the respective colors.

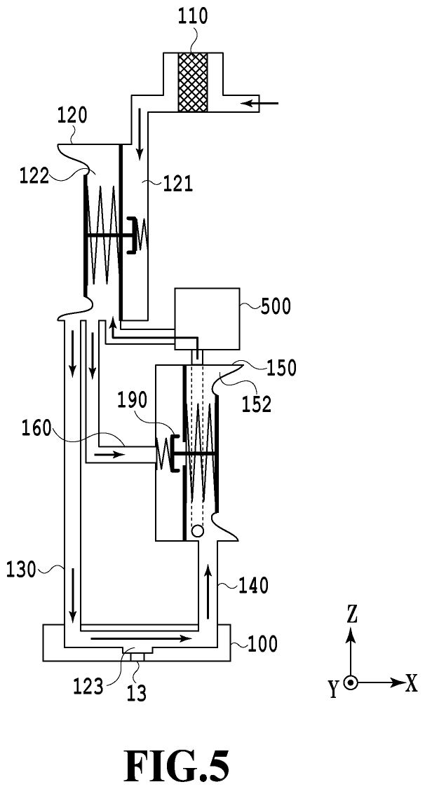

FIG. 5 is a schematic diagram showing a flow channel configuration for one color in the liquid ejection head 1 and corresponds to the ink circulation unit 54 and the ejection module 100 in FIG. 4. The arrows in FIG. 5 indicate the direction of ink flow. Ink supplied from the ink tank (not shown) is increased in pressure by a pressure increasing pump provided to the main body of the liquid ejection apparatus 50 and passes through a filter 110 while having a positive pressure and is then decreased in pressure to a predetermined negative pressure by a first pressure adjustment unit 120. The ink thus decreased in pressure is supplied to the ejection module 100 through a supply flow channel 130 and is supplied to a pressure chamber 123 where the ejection port 13 is provided. Un-ejected liquid is supplied to a second pressure control chamber 152 provided to a second pressure adjustment unit 150 through a collection flow channel 140. A circulation pump 500 is provided downstream the second pressure control chamber 152 and moves the ink back to the first pressure adjustment unit 120. A circulation path is thus configured. The supply flow channel 130 and the collection flow channel 140 correspond to the supply flow channel 20 and the collection flow channel 21 including the joint member 8 in FIG. 4.

The first pressure adjustment unit 120 and the second pressure adjustment unit 150 are connected by a bypass flow channel 160, and ink is supplied from the first pressure adjustment unit 120 to the second pressure adjustment unit 150. Ink flowing into the second pressure adjustment unit 150 through the bypass flow channel 160 and ink collected from the collection flow channel 140 are sucked into the circulation pump 500 by the driving of the circulation pump 500. The ink sucked into the circulation pump 500 then flows into the first pressure adjustment unit 120 again.

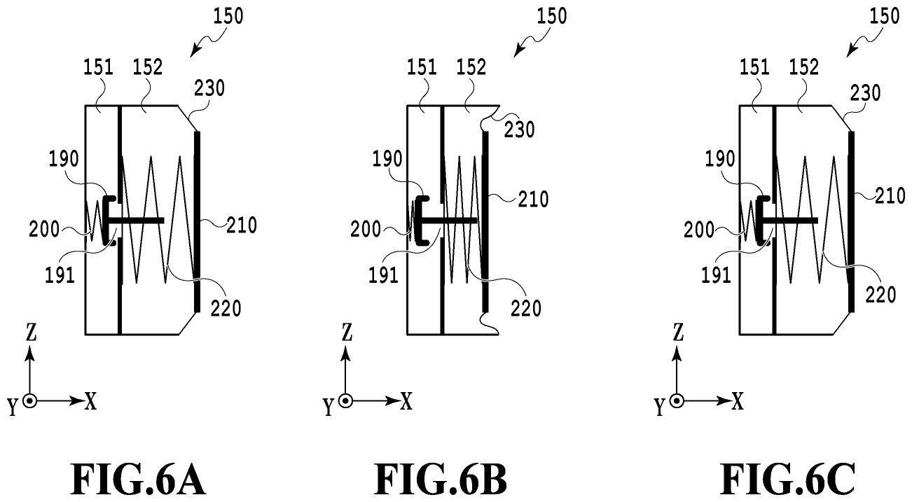

FIGS. 6A to 6C are schematic diagrams showing the structure of the second pressure adjustment unit (pressure adjustment mechanism) 150 of the present embodiment. Note that the first pressure adjustment unit 120 shown in FIG. 5 has a similar configuration to the second pressure adjustment unit 150 and is therefore not described here.

The second pressure adjustment unit 150 has a second valve chamber 151 and the second pressure control chamber 152 communicating with the second valve chamber 151 through a communication port 191. The second valve chamber 151 is provided with a valve 190 capable of opening and closing the communication port 191, and the valve 190 is biased by a valve spring 200 in a direction to close the communication port 191. The valve 190 is partially formed of an elastic body and can bring the communication port 191 into a closed state by having its elastic body part pressed against the communication port 191 in the X-direction by the valve spring 200.

Meanwhile, the open surface of the second pressure control chamber 152 is covered by a flexible member 230 and a pressure plate 210, and the pressure plate 210 is configured to be displaced in the X-direction as the flexible member 230 is displaced. For example, the pressure plate 210, which is formed of a resin molded component, is thermally fused and fixed to the flexible member 230, which is formed of a resin film. The flexible member 230 and the pressure plate 210 are biased by a pressure adjustment spring 220 in a direction to expand the volume of the second pressure control chamber 152 (the X-direction). As the negative pressure inside the second pressure control chamber 152 increases, the pressure plate 210 and the flexible member 230 are displaced in the volume decreasing direction (a −X-direction). Also, once the second pressure control chamber 152 reaches a certain negative pressure, the pressure plate 210 comes into contact with the tip of the valve 190. After the negative pressure increases further, the valve 190 moves in the −X-direction against the bias force from the valve spring 200, bringing the communication port 191 into an open state (see FIG. 6B).

By setting a higher pressure for the second valve chamber 151 than for the second pressure control chamber 152, ink flows from the second valve chamber 151 into the second pressure control chamber 152 once the communication port 191 is brought into an open state. Once ink flows from the second valve chamber 151 into the second pressure control chamber 152, the flexible member 230 and the pressure plate 210 are displaced in a direction to increase the volume of the second pressure control chamber 152 (the X-direction), bringing the communication port 191 into a closed state (see FIG. 6C).

In this way, once a certain negative pressure is reached and exceeded, ink flows from the second valve chamber 151 into the second pressure control chamber 152 through the communication port 191, which prevents the negative pressure from becoming higher than that. Thus, the second pressure control chamber 152 can be controlled to have a pressure within a certain range.

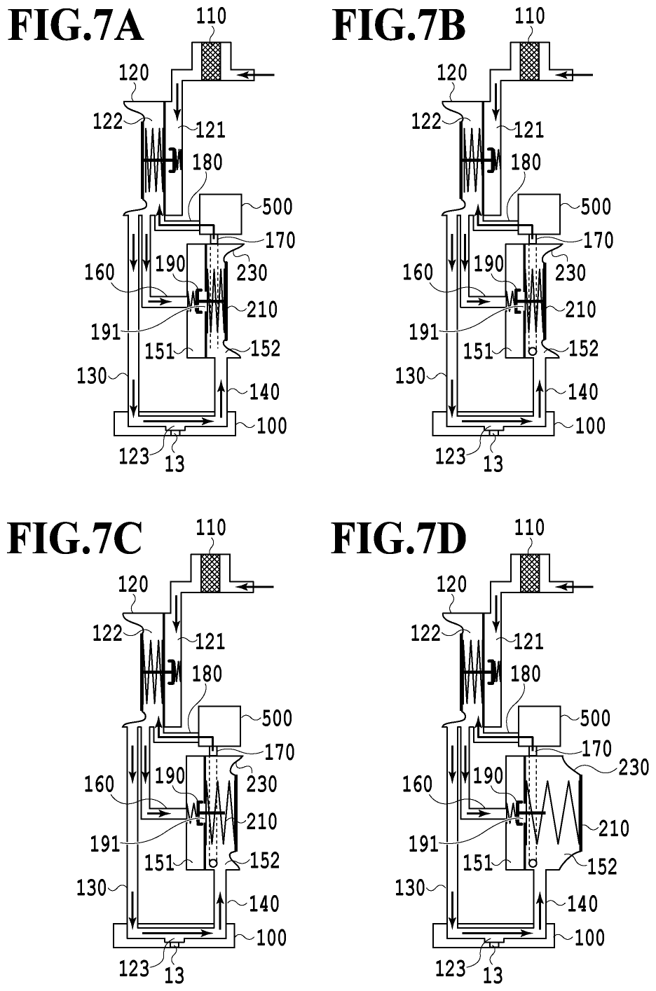

FIGS. 7A to 7D are diagrams showing how ink flows in the liquid ejection head 1 in the respective phases of operation of the circulation pump 500. The liquid ejection head 1 has a first pressure control chamber 122 communicating with a first side of the pressure chamber 123 and the second pressure control chamber 152 communicating with a second side of the pressure chamber 123. The operation is described below using FIG. 7A. FIG. 7A schematically shows how ink circulates during an ejection operation. During an ejection operation, the circulation pump 500 is on, and ink exiting from the first pressure control chamber 122 is supplied to the supply flow channel 130 and the bypass flow channel 160. The ink supplied to the supply flow channel 130 passes through the ejection module 100 including the pressure chamber 123, is supplied to the collection flow channel 140, and is then supplied to the second pressure control chamber 152. Meanwhile, ink supplied from the first pressure control chamber 122 to the bypass flow channel 160 is supplied to the second pressure control chamber 152 through the second valve chamber 151. The ink supplied to the second pressure control chamber 152 is supplied to the first pressure control chamber 122 through a pump inlet flow channel 170, the circulation pump 500, and a pump outlet flow channel 180. In this way, liquid is circulated between the pressure chamber 123 and the outside by a difference between the negative pressure in the first pressure control chamber 122 and the negative pressure in the second pressure control chamber 152.

Setting a higher control pressure for the first pressure control chamber 122 than for the second pressure control chamber 152 causes ink supplied to the first pressure control chamber 122 to be supplied to the ejection module 100 through the supply flow channel 130. After that, the ink circulates in the liquid ejection head 1, flowing to the second pressure control chamber 152 through the collection flow channel 140. The amount of ink passed through the ejection module 100 by circulation is determined by the difference in control pressure between the first pressure control chamber 122 and the second pressure control chamber 152. Thus, the control pressures of the first pressure control chamber 122 and the second pressure control chamber 152 are set so as to achieve an ink amount with which thickening of ink near the ejection port 13 in the ejection module 100 can be suppressed. Also, ink consumed by ejection is compensated for by supply of ink from the ink tank (not shown) to the first pressure control chamber 122 through the filter 110 and a first valve chamber 121.

FIG. 7B shows how ink circulates after the ejection operation ends and the circulation pump 500 is turned off. At the point where the ejection operation ends and the circulation pump 500 is turned off, the pressure in the first pressure control chamber 122 and the pressure in the second pressure control chamber 152 are still not different from their control pressures during ejection; hence, ink continues to circulate according to pressure difference as shown in FIG. 7B. Specifically, ink continues to circulate in the ejection modules 100 as follows: ink is supplied from the first pressure control chamber 122 to the ejection module 100 through the supply flow channel 130 and then reaches the second pressure control chamber 152 through the collection flow channel 140. Further, circulation takes place in the bypass flow channel 160 as well, flowing from the first pressure control chamber 122 to the second pressure control chamber 152 through the bypass flow channel 160 and the second valve chamber 151. To compensate for the amount of ink moved by the circulation from the first pressure control chamber 122 to the second pressure control chamber 152, ink is supplied from the ink tank (not shown) to the first pressure control chamber 122 through the filter 110 and the first valve chamber 121. Thus, the amount of ink contained in the first pressure control chamber 122 remains constant.

Meanwhile, the pressure in the second pressure control chamber 152 changes with time according to a change in the amount of ink contained therein due to ink flowing thereinto from the first pressure control chamber 122. Specifically, pressure changes until the communication port 191 in the state in FIG. 7B is brought into a closed state as shown in FIG. 7C, causing the second valve chamber 151 and the second pressure control chamber 152 to no longer communicate with each other. After that, the pressure plate 210 and the valve 190 come out of abutment, and pressure changes until the pressure plate 210 and the flexible member 230 are displaced to a point where the internal volume of the second pressure control chamber 152 becomes maximum as shown in FIG. 7D.

After the state in FIG. 7C, there is no ink flowing in the bypass flow channel 160, i.e., a flow from the first pressure control chamber 122 to the second pressure control chamber 152 through the bypass flow channel 160 and the second valve chamber 151. Then, ink is supplied from the first pressure control chamber 122 to the ejection module 100 through the supply flow channel 130, and after that, circulation through the ejection module 100 takes place, flowing to the second pressure control chamber 152 through the collection flow channel 140. Because ink moves from the first pressure control chamber 122 to the second pressure control chamber 152 due to a pressure difference between the first pressure control chamber 122 and the second pressure control chamber 152, ink stops moving once the pressure in the second pressure control chamber 152 and the pressure in the first pressure control chamber 122 equal.

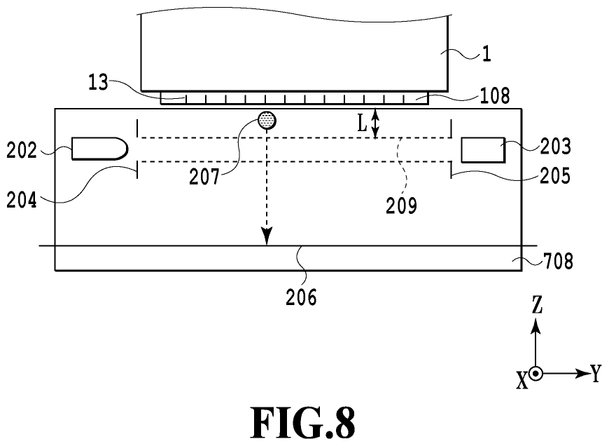

FIG. 8 is a rough schematic diagram showing the ejection speed measurement unit 708, which is an ink ejection state detection unit of the present embodiment, and part of the liquid ejection head 1. In FIG. 8, the liquid ejection head 1 is seen from the X-direction. The ejection speed measurement unit 708 has the light emission element 202, the light reception unit 203, an aperture 205 for the light emission element, an aperture 204 for the light reception element, and an ink absorber 206 that absorbs an ejected ink droplet 207. The light emission element 202 and the light reception unit 203 are disposed so that a flux of light 209 obstructs the ink droplet 207 ejected from the liquid ejection head 1. For example, an infrared LED with a narrow angle of directivity is used as the light emission element 202, and a voltage of 5 V is applied to the light emission element 202 to emit light. Then, the light reception unit 203 reads the amount of light of the flux of light 209 that comes from the light emission element 202 and enters the light reception unit 203.

In detecting the ejection speed of the ink droplet 207, a voltage is applied to the light emission element 202. Also, for example, a photodiode exhibiting the highest spectral sensitivity characteristics in the infrared region is used as the light reception unit 203. In detecting the ejection speeds of the ink droplets 207 ejected from the ejection ports 13, the ejection ports 13 are sequentially driven (the heaters are heated up), and the ink droplet 207 is ejected from each ejection port 13. The ejected ink droplet 207 passes through (blocks) the flux of light 209 and lands on and absorbed by the spongy ink absorber 206. The light reception unit 203 detects the passage of the ink droplet 207 through the flux of light 209. In such a configuration, an ejection speed v of the ink droplet 207 can be calculated from v=L/T, where L is the distance from the ejection port 13 to the flux of light 209 and T is a time difference between a rise of an ejection signal and a rise of a detection signal. The ejection speed measurement unit 708 is thus configured to be able to obtain the ejection speed of the ink droplet 207.

In a case where ink is not being circulated normally, even if ink is ejected with no problem immediately after preliminary ejection, after a lapse of a predetermined period of time since preliminary ejection, ink may be ejected at a low speed or may fail to be ejected at all (which is hereinafter also referred to as failed ejection). It is known that this is because before the predetermined period of time elapses, part of components of the ink evaporates from the ejection port 13, making the ink thicker in viscosity.

Thus, in the present embodiment, a comparison of ejection speed is made between ejection immediately after preliminary ejection and ejection after a lapse of a predetermined period of time since the preliminary ejection, and the circulation state determination unit 709 determines whether ink is being circulated normally based on the comparison result.

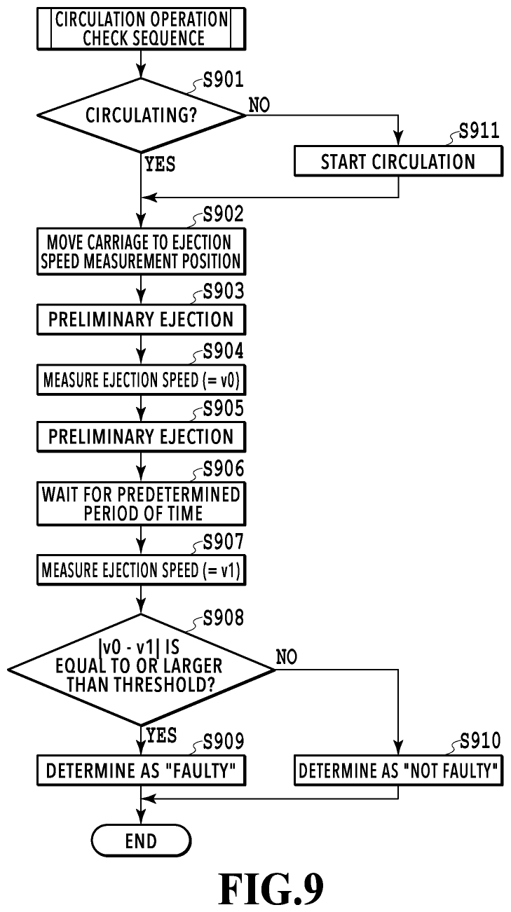

FIG. 9 is a flowchart showing processing for a circulation operation check (circulation operation detection) sequence in the present embodiment. A series of steps of the processing shown in FIG. 9 are implemented by the CPU 402 of the liquid ejection apparatus 50 loading program code stored in the memory 403 and executing the program code. Alternatively, some or all of the functions in the steps in FIG. 9 may be implemented by hardware such as an ASIC or an electric circuit. Note that the letter “S” in the description of processing means that it is a step in the flowchart. Processing for the circulation operation check sequence in the present embodiment is described below using the flowchart in FIG. 9. In the following FIG. 9, the CPU 402 functions as the circulation state determination unit.

Once the circulation operation check sequence starts, in S901 the CPU 402 causes the print control unit 401 to checks whether the circulation pump 500 is running. If the circulation pump 500 is not running, the CPU 402 proceeds to S911 to run the circulation pump 500. If the circulation pump 500 is running, the CPU 402 proceeds to S902.

In S902, to measure the ejection speed, the CPU 402 causes the print control unit 401 to control the motor driver 409 to move the carriage 53 having the liquid ejection head 1 mounted thereon to an ejection speed measurement position. The CPU 402 proceeds to S903 and causes the print control unit 401 to control the liquid ejection head driver 412 to carry out preliminary ejection for refreshing the ink before measuring the ejection speed. This preliminary ejection is “the previous ejection” as referred to in an ejection operation in S904. After that, the CPU 402 proceeds to S904 and controls the liquid ejection head driver 412 to measure an ejection speed “v0.” Specifically, for each of the plurality of ejection ports 13, an ejection operation and an ejection speed measurement are sequentially performed to find the average value “v0” of the ejection speeds of the plurality of ejection ports. In this way, the ejection speed “v0” is measured immediately after the preliminary ejection.

In S905, the CPU 402 carries out preliminary ejection again, and in S906, causes the print control unit 401 to wait for a predetermined period of time to pass. The waiting time is two seconds in the present embodiment. After waiting for the predetermined period of time to pass, the CPU 402 proceeds to S907 and controls the liquid ejection head driver 412 to eject ink again and measure an ejection speed “v1.” The ejection speed “v1” is obtained in the same manner as the “ejection speed “v0.” In this way, the ejection speed “v1” is measured after a lapse of a predetermined period since the preliminary ejection.

Next, the CPU 402 proceeds to S908 and determines whether a difference “|v0−v1|” between the ejection speed “v0” and the ejection speed “v1” is equal to or larger than a threshold (a predetermined value). If the difference between the ejection speed “v0” and the ejection speed “v1” is equal to or smaller than the threshold, the CPU 402, judging that there is not so much difference between the ejection speed “v0” and the ejection speed “v1,” proceeds to S910 to determine that the circulation mechanism is operating with no problem, and ends the processing. Also, if the difference between the ejection speed “v0” and the ejection speed “v1” is equal to or larger than the threshold, the CPU 402, judging that the ejection speed “v1” is low due to abnormal circulation, proceeds to S909 to determine that the circulation mechanism is operating faultily, and ends the processing.

In this way, in the present embodiment, the ejection speeds of the respective ejection ports are measured, so that the state of circulation operation can be detected with high accuracy.

In the present embodiment, the ejection speed v0 immediately after the preliminary ejection is approximately 10 meters per second (m/sec). In a case where the circulation mechanism is malfunctioning and not circulating ink, in two seconds after the preliminary ejection, ink fails to be ejected (v1=0 m/sec), and hence, |v0−v1|=10 m/sec. Because the threshold is 5 m/sec in the present embodiment, it is determined that the circulation mechanism is faulty before the ink fails to be ejected completely.

Once it is determined that the circulation mechanism is faulty, an error message is displayed on the display panel of the main body of the liquid ejection apparatus 50. The error message may be a sound warning. Note that it is preferable that the measurement of the ejection speed “v0” is performed continuously from the preliminary ejection, but the ejection speed “v0” may be measured after a lapse of a waiting time since the preliminary ejection as long as the waiting time is shorter than the waiting time for the measurement of the ejection speed “v1.” Also, although the time for which the CPU 402 waits before measuring the ejection speed “v1” is two seconds in the present embodiment, the waiting time is not particularly limited to two seconds as long as the number of seconds allow ink to be ejected at a lower speed or not to be ejected at all due to evaporation from the ejection ports.

In the present embodiment, the circulation operation check sequence described above is carried out at the timing of operating the circulation mechanism to determine whether circulation is faulty. Thus, in a case where circulation is faulty, problems that may be caused by faulty circulation, such as low image quality and ink adherence, can be prevented.

In this way, faulty ink circulation operation is detected by a comparison between an ejection state measured after a lapse of a first period of time since the previous ejection like the preliminary ejection and an ejection state measured after a lapse of a second period of time shorter than the first period of time. Thus, a liquid ejection apparatus and a circulation state determination method capable of properly detecting degradation of circulation capability can be provided.

### Second Embodiment

A second embodiment of the present disclosure is described below with reference to the drawings. Note that because the present embodiment has the same basic configuration as the first embodiment, the following describes configurations characteristic to the present embodiment.

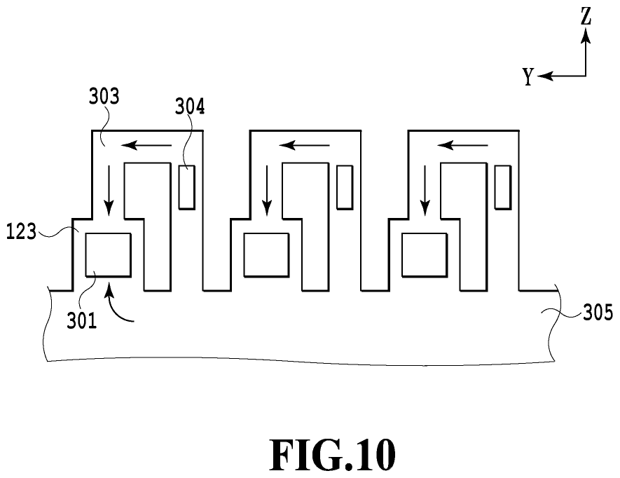

FIG. 10 is a rough schematic diagram showing an area near the ejection ports in the present embodiment. In the present embodiment, heat generation elements (pressure generation elements) 304 not contributing to ink ejection are provided in flow channels 303 leading to the pressure chambers 123. Note that piezoelectric elements may be used as the heat generation elements 304.

The pressure chambers 123 communicate with the respective flow channels 303 and are supplied with ink from a common liquid chamber 305 and the respective flow channels 303. To eject an ink droplet, a voltage is applied to the heat generation resistance element 301 to generate an air bubble in the ink near the heat generation resistance element 301, and pressure produced by the air bubble causes the ink in the pressure chamber 123 to be ejected from the ejection port (not shown). Once the air bubble thus generated breaks, ink is supplied to the pressure chamber 123 from the flow channel 303 and the common liquid chamber 305.

The heat generation elements 304 are used in replacing ink in the pressure chambers 123 in the event where the ink fails to be ejected. A voltage is applied to the heat generation elements 304 to generate air bubbles, and the pressure produced by the air bubbles moves the ink inside the flow channels 303 to push the ink out of the pressure chambers 123, replacing the ink in the flow channels 303. By repeating this operation as needed, fresh ink can be supplied to the pressure chamber 123.

### Third Embodiment

A third embodiment of the present disclosure is described below with reference to the drawings. Note that because the present embodiment has the same basic configuration as the first embodiment, the following describes configurations characteristic to the present embodiment.

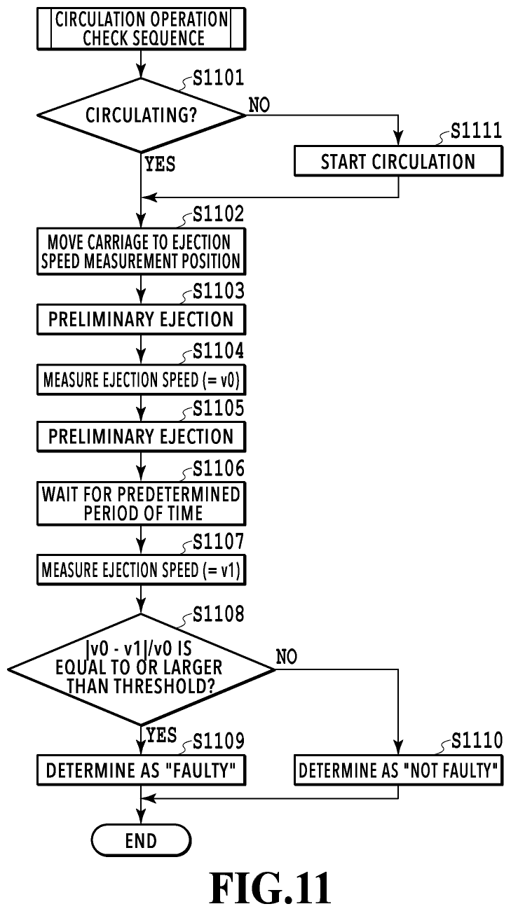

FIG. 11 is a flowchart showing processing for the circulation operation check sequence in the present embodiment. A series of steps of the processing shown in FIG. 11 are implemented by the CPU 402 of the liquid ejection apparatus 50 loading program code stored in the memory 403 and executing the program code. Alternatively, some or all of the functions in the steps in FIG. 11 may be implemented by hardware such as an ASIC or an electric circuit. Note that the letter “S” in the description of processing means that it is a step in the flowchart. Processing from S1101 to S1107 is the same as the processing in the first embodiment and is therefore not described here.

In S1108, the CPU 402 causes the print control unit to determine whether the circulation operation is faulty by comparing a rate of change in the ejection speed with a threshold, the rate of change being obtained by dividing “|v0−v1|,” which is a difference between the ejection speed “v0” and the ejection speed “v1,” by the ejection speed “v0.” If the rate of change calculated is equal to or smaller than the threshold, the CPU 402, judging that there is not so much difference between the ejection speed “v0” and the ejection speed “v1,” proceeds to S1110 to determine that the circulation mechanism is operating with no problem, and ends the processing. Also, if the calculate rate of change is equal to or larger than the threshold, the CPU 402, judging that the ejection speed “v1” is slowing down because something is going wrong with the circulation, proceeds to S1109 to determine that the circulation mechanism is operating faultily, and ends the processing.

### Fourth Embodiment

A fourth embodiment of the present disclosure is described below with reference to the drawings. Note that because the present embodiment has the same basic configuration as the first embodiment, the following describes configurations characteristic to the present embodiment. Note that the present embodiment is limited to heat generation resistance elements (heaters), and piezoelectric elements cannot be used.

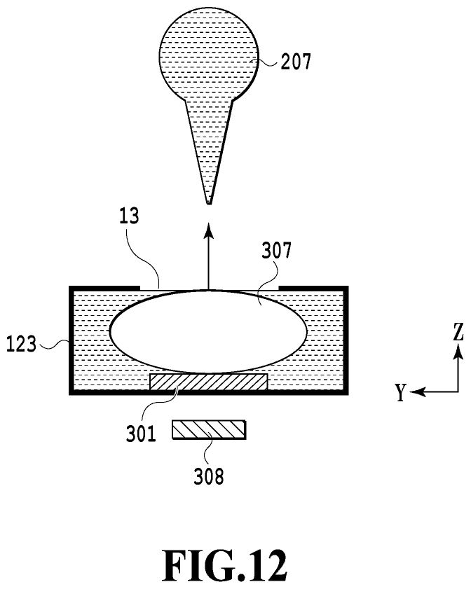

FIG. 12 is a rough schematic diagram showing an ejection state detection unit in the present embodiment. In the present embodiment, a failed ejection test is conducted using a temperature sensor 308. A result of the failed ejection test is used to determine whether circulation is being performed faultily. A method of the failed ejection test in the present embodiment is described below.

A voltage is applied to the heat generation resistance element 301 to generate an air bubble 307 and eject the ink droplet 207 from the ejection port 13. One temperature sensor 308 is provided under each heat generation resistance element 301. The temperature sensor 308 measures temperature near the heat generation resistance element 301 at the time of ejection.

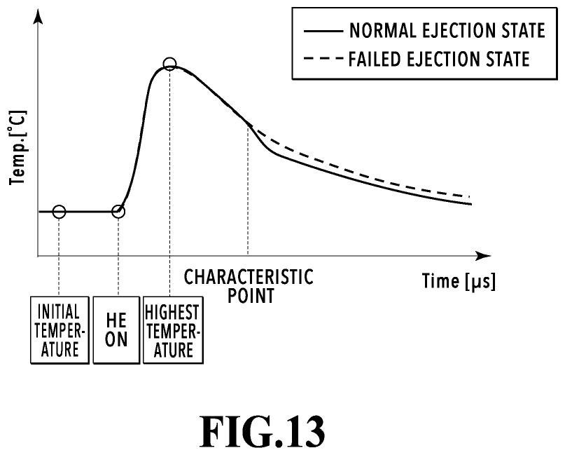

FIG. 13 is a graph showing a temperature profile (temperature change) for normal ejection and a temperature profile for failed ejection obtained by the temperature sensor 308 upon application of a drive voltage to the heat generation resistance element 301. The horizontal axis represents time, and the vertical axis represents temperature. Upon ejection of ink, temperature near the heat generation resistance element 301 immediately rises due to application of a voltage to the heat generation resistance element 301. After that, in a case where the ink is ejected normally, the ejected ink droplet 207 brings the heat with it, and ink not increased in temperature is supplied. Consequently, temperature near the heat generation resistance element 301 drastically drops. By contrast, in a case where the ink fails to be ejected, the ink droplet 207 is not ejected, and also, ink not increased in temperature is not supplied. Consequently, temperature near the heat generation resistance element 301 drops not drastically, but gently.

As the temperature profiles in FIG. 13 show, in the event where the ejection operation is done normally, the temperature detected by the temperature sensor 308 has a characteristic point where the temperature drastically drops after reaching the highest temperature (the solid-line graph). By contrast, in the event where the ink fails to be ejected, there is no such characteristic point where temperature drops drastically (the dotted-line graph). Whether ink is ejected normally can be determined by detecting the presence of the characteristic point on the temperature profile.

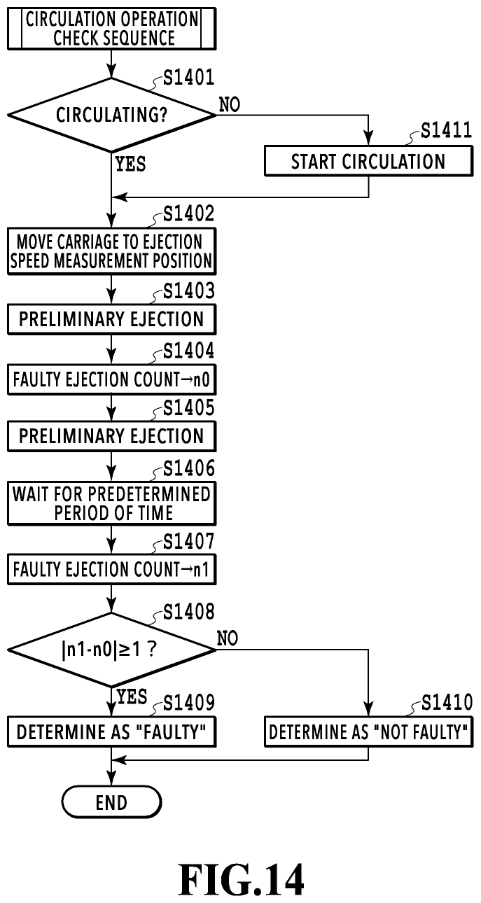

FIG. 14 is a flowchart showing processing for a circulation operation check sequence in the present embodiment. A series of steps of the processing shown in FIG. 14 are implemented by the CPU 402 of the liquid ejection apparatus 50 loading program code stored in the memory 403 and executing the program code. Alternatively, some or all of the functions in the steps in FIG. 14 may be implemented by hardware such as an ASIC or an electric circuit. Note that the letter “S” in the description of processing means that it is a step in the flowchart. The processing for the circulation operation check sequence in the present embodiment is described below using the flowchart in FIG. 14. Processing from S1401 to S1403 is the same as the processing in the first embodiment and is therefore not described here.

In S1404, the CPU 402 performs ejection and obtains the number of nozzles failing to eject. Specifically, for each of the plurality of the ejection ports 13, the CPU 402 detects whether there is a characteristic point described in FIG. 14, and a faulty ejection count is found and set as “n0.” In this way, the faulty ejection count (the number of ejection ports failing to eject) “n0” is measured immediately after the preliminary ejection.

In S1405, the CPU 402 carries out the preliminary ejection again, and in S1406, causes the print control unit 401 to wait for a predetermined period of time to pass. In the present embodiment, the waiting time is two seconds. After waiting for the predetermined period of time, the CPU 402 proceeds to S1407 to control the liquid ejection head driver 412 to perform ejection again, and measure a faulty ejection count “n1.” The faulty ejection count “n1” is obtained in the same manner as the faulty ejection count “n0.” In this way, the faulty ejection count “n1” is measured after a lapse of a predetermined period of time since the preliminary ejection.

Next, the CPU 402 proceeds to S1408 to determine whether “n1−n0,” which is a difference between the faulty ejection count “n0” and the faulty ejection count “n1,” is 1 or larger. If the difference between the faulty ejection count “n0” and the faulty ejection count “n1” is zero, the CPU 402 proceeds to S1410 to determine that the circulation mechanism is operating with no problem, and ends the processing. Also, if the difference between the faulty ejection count “n0” and the faulty ejection count “n1” is 1 or larger, which means that the circulation is not performed normally, the CPU 402 proceeds to S1409 to determine that the circulation mechanism is operating faultily, and ends the processing.

In this way, the failed ejection test is conducted using the temperature sensors 308, and it is determined that circulation is being performed faultily in a case where the faulty ejection count measured for the ejection performed after a wait for a predetermined period of time is larger. Thus, a liquid ejection apparatus capable of properly detecting degradation of circulation capability can be provided.

### Fifth Embodiment

A fifth embodiment of the present disclosure is described below with reference to the drawings. Note that because the present embodiment has the same basic configuration as the first embodiment, the following describes configurations characteristic to the present embodiment. The present embodiment describes a recovery sequence performed in a case where it is determined in the circulation operation check sequence that circulation is being performed faultily.

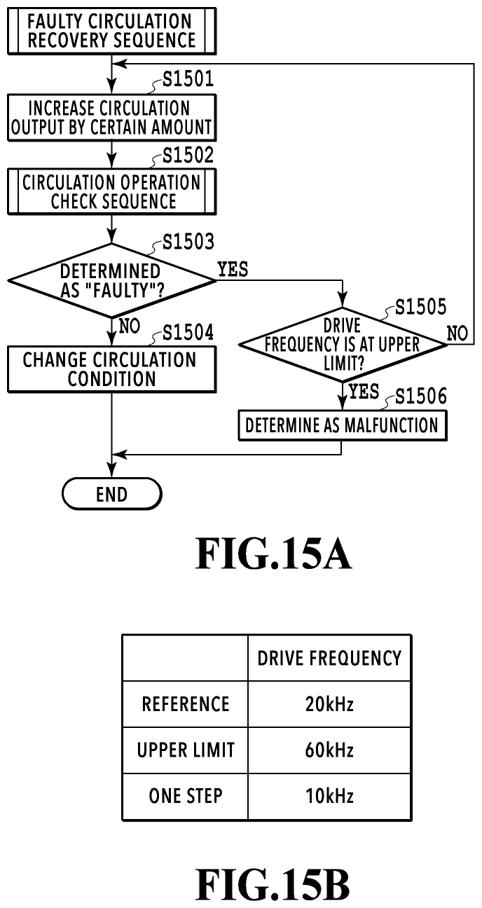

FIG. 15A is a flowchart showing processing for the faulty circulation recovery sequence in the present embodiment. FIG. 15B is a table showing drive frequencies for the circulation pump. A series of steps of the processing shown in FIG. 15A are implemented by the CPU 402 of the liquid ejection apparatus 50 loading program code stored in the memory 403 and executing the program code. Alternatively, some or all of the functions in the steps in FIG. 15A may be implemented by hardware such as an ASIC or an electric circuit. Note that the letter “S” in the description of processing means that it is a step in the flowchart.

If it is determined in the circulation operation check sequence that the circulation operation is performed faultily, in S1501 the CPU 402 drives the circulation pump 500 at a drive frequency of 30 kHz (kilohertz), which is raised by one step from 20 kHz, a reference frequency. In the present embodiment, one step equals 10 kHz (see FIG. 15B), and the drive frequency is raised from 20 kHz as a reference by 10 kHz at a time. The drive frequency of the circulation pump 500 is increased to raise the liquid circulation speed. After that, in S1502 the CPU 402 performs the circulation operation check sequence described in the above embodiments. In S1503, the CPU 402 determines whether it is determined in the circulation operation check sequence that circulation is being performed faultily. The CPU 402 proceeds to S1505 if it is determined that circulation is being performed faultily, or proceeds to S1504 if it is not determined that circulation is being performed faultily.

After proceeding to S1505, the CPU 402 determines whether the drive frequency for the circulation pump 500 is at the upper limit. If not, the CPU 402 proceeds back to S1501 and repeats the processing. If so, the CPU 402 proceeds to S1506 to determine that the circulation mechanism is malfunctioning and display an error message on the panel of the main body, and ends the processing. Note that 60 kHz is the upper limit of the drive frequency in the present embodiment (see FIG. 15B). If proceeding from S1503 to S1504, the CPU 402 sets 30 kHz as the subsequent drive frequency condition for the circulation pump 500 and ends the processing.

In this way, in a case where the malfunction of the circulation mechanism is of a recoverable level, the configuration of the present embodiment can prolong the life of the circulation mechanism.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-027404, filed Feb. 27, 2024, which is hereby incorporated by reference wherein in its entirety.

What is claimed is:

1. A liquid ejection apparatus comprising:
an ejection unit that ejects liquid in a pressure chamber from an ejection port by driving a pressure generation element;
a circulation unit that circulates the liquid between the pressure chamber and outside;
an ejection state detection unit that detects an ejection state of the liquid ejected from the ejection port; and
a circulation state determination unit that determines a state of circulation performed by the circulation unit, wherein
the circulation state determination unit determines the state of circulation based on a difference between a result detected by the ejection state detection unit after a lapse of a first period of time since a previous ejection operation performed by the ejection unit and a result detected by the ejection state detection unit after a lapse of a second period of time since a previous ejection operation performed by the ejection unit, the second period of time being longer than the first period of time.

2. The liquid ejection apparatus according to claim 1, wherein
the ejection state detection unit detects an ejection speed of the liquid ejected from the ejection port, and
the circulation state determination unit determines that the state of circulation is faulty in a case where a difference between an ejection speed detected after the lapse of the first period of time since the previous ejection operation performed by the ejection unit and an ejection speed detected after the lapse of the second period of time since the previous ejection operation performed by the ejection unit is equal to or larger than a predetermined threshold.

3. The liquid ejection apparatus according to claim 1, wherein
the ejection state detection unit detects an ejection speed of the liquid ejected from the ejection port, and
the circulation state determination unit determines that the state of circulation is faulty in a case where a rate of change between an ejection speed detected after the lapse of the first period of time since the previous ejection operation performed by the ejection unit and an ejection speed detected after the lapse of the second period of time since the previous ejection operation performed by the ejection unit is equal to or larger than a predetermined threshold.

4. The liquid ejection apparatus according to claim 1, wherein
the ejection state detection unit detects a number of ejection ports failing to eject among a plurality of the ejection ports, and
the circulation state determination unit determines that the state of circulation is faulty in a case where the number of ejection ports failing to eject detected after the lapse of the second period of time since the previous ejection operation performed by the ejection unit is larger than the number of ejection ports failing to eject detected after the lapse of the first period of time since the previous ejection operation performed by the ejection unit.

5. The liquid ejection apparatus according to claim 4, wherein
the pressure generation element is a heat generation resistance element, and
the ejection state detection unit detects whether the ejection state is faulty based on a change in temperature of the heat generation resistance element caused by an ejection operation.

6. The liquid ejection apparatus according to claim 1, comprising:
a first pressure generation element provided in the pressure chamber and
a second pressure generation element provided in a flow channel communicating with the pressure chamber, wherein
the circulation unit circulates the liquid between the pressure chamber and the outside using the second pressure generation element provided in the flow channel communicating with the pressure chamber.

7. The liquid ejection apparatus according to claim 1, wherein
the circulation unit has a first pressure adjustment mechanism communicating with a first side of the pressure chamber and a second pressure adjustment mechanism communicating with a second side of the pressure chamber, and
the circulation unit circulates the liquid in the pressure chamber using a difference in a negative pressure in the first pressure adjustment mechanism and a negative pressure in the second pressure adjustment mechanism.

8. The liquid ejection apparatus according to claim 6, wherein
the second pressure generation element in the flow channel is a piezoelectric element or a heater formed of a heat generation element.

9. The liquid ejection apparatus according to claim 1, wherein
an error message is displayed in a case where the circulation state determination unit determines that the circulation state is faulty.

10. The liquid ejection apparatus according to claim 9, wherein
the circulation unit increases circulation speed in a case where the circulation state determination unit determines that the circulation state is faulty.

11. The liquid ejection apparatus according to claim 10, wherein
an error message is displayed in a case where the circulation state determination unit determines that the circulation state is faulty and the circulation speed is at an upper limit.

12. The liquid ejection apparatus according to claim 1, wherein
the ejection state detection unit detects an ejection speed of the liquid ejected from the ejection port, and
the result detected by the ejection state detection unit after the lapse of the first period of time since the previous ejection operation performed by the ejection unit is a speed of the liquid ejected immediately after preliminary ejection.

13. A circulation state determination method for determining a state of circulation performed by a circulation unit in a liquid ejection apparatus having
an ejection unit that ejects liquid in the pressure chamber from an ejection port by driving a pressure generation element,
the circulation unit that circulates the liquid between the pressure chamber and outside, and
an ejection state detection unit that detects an ejection state of the liquid ejected from the ejection port, the method comprising:
a first detection step of causing the ejection state detection unit to detect the ejection state of the liquid ejected from the ejection port after a lapse of a first period of time since a previous ejection operation performed by the ejection unit;
a second detection step of causing the ejection state detection unit to detect the ejection state of the liquid ejected from the ejection port after a lapse of a second period of time since a previous ejection operation performed by the ejection unit, the second period of time being longer than the first period of time; and
determining the state of circulation based on a difference between a result of the first detection step and a result of the second detection step.
